(19) United States
(12) Patent Application Publication
(10) Pub. No.: US 2005/0155842 A1
(43) Pub. Date: Jul. 21, 2005

(54) Unit and method for reordering confectionery products, such as sweets and similar

(76) Inventors: Sandro Salicini, Monterenzio (IT); Daniele Civolani, Molinella (IT)

Correspondence Address: LADAS & PARRY, 26 WEST 61ST STREET, NEW YORK, NY, 10023, US

(21) Appl. No.: 10/503,517

(22) PCT Filed: Feb. 5, 2003
(86) PCT No.: PCT/IT03/00055

(30) Foreign Application Priority Data
Feb. 6, 2002 (IT) BO2002A000065

(51) Int. Cl. A23G 7/00

(52) U.S. Cl. 198/459.2; 198/450

(57) ABSTRACT

A unit for reordering sweets has a spacing disk, which rotates about a first axis, receives bulk-fed sweets, and has a number of seats, each for receiving a respective sweet, and each fed along a path; and a makeup device, which is located along the path, upstream from an extraction station for extracting the sweets, and has a detector located along the path to detect any vacant seats, and a feed device for supplying an orderly succession of sweets and located between the detector and the extraction station to feed sweets selectively into the vacant seats.

### TECHNICAL FIELD

The present invention relates to a unit and method for reordering confectionery products, such as sweets and similar.

Sweets, to which reference is made in the following description purely by way of example, normally come off production machines in orderly successions, after which, they are stored in bulk and later fed to wrapping machines where they must be formed back into an equally spaced succession by means of a reordering unit.

### BACKGROUND ART

One known type of reordering unit comprises a spacing disk rotating about a substantially vertical axis and having a truncated-cone-shaped plate, which slopes down to a number of seats equally spaced about the spacing disk axis and fed along a given path. The sweets are fed in bulk, at said axis, onto the truncated-cone-shaped portion of the spacing disk, and, as the spacing disk rotates, slide or roll along the truncated-cone-shaped portion into the seats. The sweets are later extracted at an extraction station located along said given path, and are fed to a wrapping machine, which wraps each sweet in a sheet of wrapping material. Though the seats are sized to ensure each is only engaged by one sweet, the random way in which the sweets are spaced along the spacing disk does not guarantee every seat fed through the extraction station is actually engaged, the likelihood of which depends on the shape of the sweet. For example, a spherical sweet is more likely to engage a seat on the spacing disk much faster than a triangular parallelepiped-shaped sweet. That is, a spherical sweet, which can roll and is therefore more mobile, need simply reach the seat, whereas a triangular parallelepiped-shaped sweet must also be oriented the same way as the seat.

In either case, the presence of vacant seats at the extraction station, i.e. non-supply of sweets to the wrapping machine, has a negative effect on the follow-up wrapping process.

### DISCLOSURE OF INVENTION

It is an object of the present invention to provide a unit for reordering sweets, designed to eliminate the drawbacks of known units, and which provides for supplying sweets in an orderly uninterrupted succession.

According to the present invention, there is provided a unit for reordering confectionery products, such as sweets and similar; the unit comprising a spacing disk, which receives sweets in bulk, comprises a number of peripheral first seats, each for receiving a respective sweet, and rotates about a substantially vertical first axis to feed said first seats along a first path through an extraction station for extracting the sweets; the unit being characterized by comprising a makeup device for making up the sweets inside any vacant first seats; the makeup device comprising a detector located along said first path to detect any vacant first seats, and a sweet feed device located along said first path, between said detector and said extraction station, to feed sweets selectively into the vacant said first seats.

The present invention also relates to a method of reordering confectionery products, such as sweets and similar.

According to the present invention, there is provided a method of reordering confectionery products, such as sweets and similar; the method comprising feeding sweets in bulk onto a spacing disk comprising a number of peripheral first seats, each for receiving a respective sweet; and rotating the spacing disk about a substantially vertical first axis to feed said first seats along a first path through an extraction station for extracting the sweets; the method being characterized by detecting any vacant first seats by means of a detector located upstream from the extraction station; and making up the sweets inside the vacant first seats, between said detector and the extraction station, by means of a sweet feed device.

### BRIEF DESCRIPTION OF THE DRAWINGS

A non-limiting embodiment of the present invention will be described by way of example with reference to the accompanying drawings, in which:

FIG. 1 shows a view in perspective, with parts in section and parts removed for clarity, of a reordering unit in accordance with the present invention;

FIGS. 2 and 3 show larger-scale sections, with parts removed for clarity, of the FIG. 1 unit at two different operating stages.

### BEST MODE FOR CARRYING OUT THE INVENTION

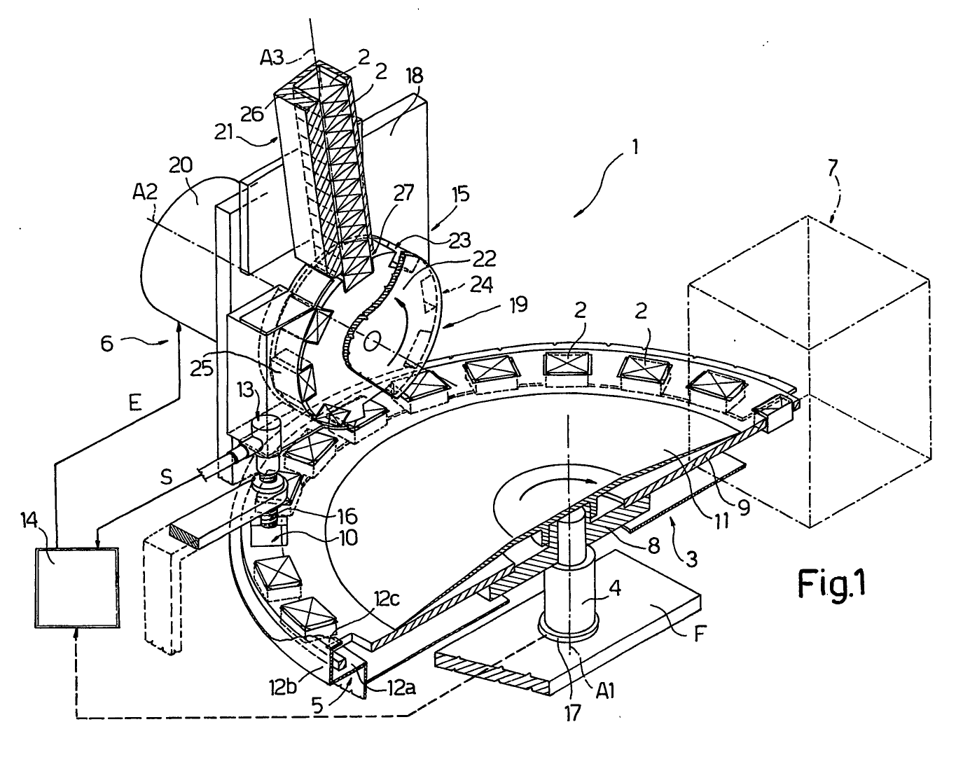

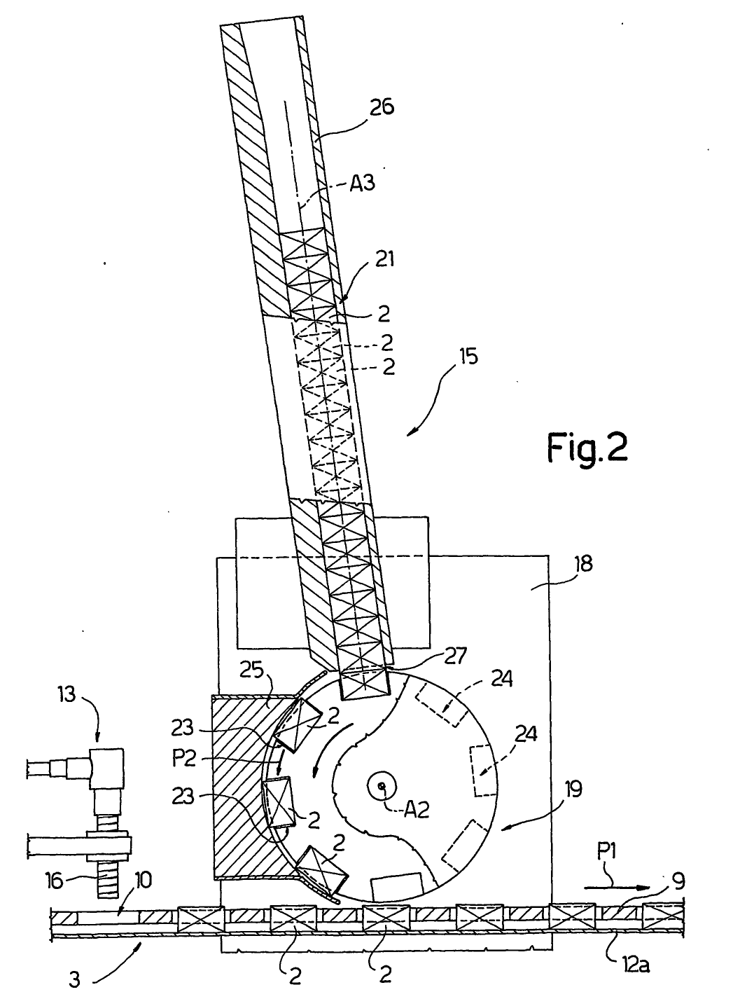

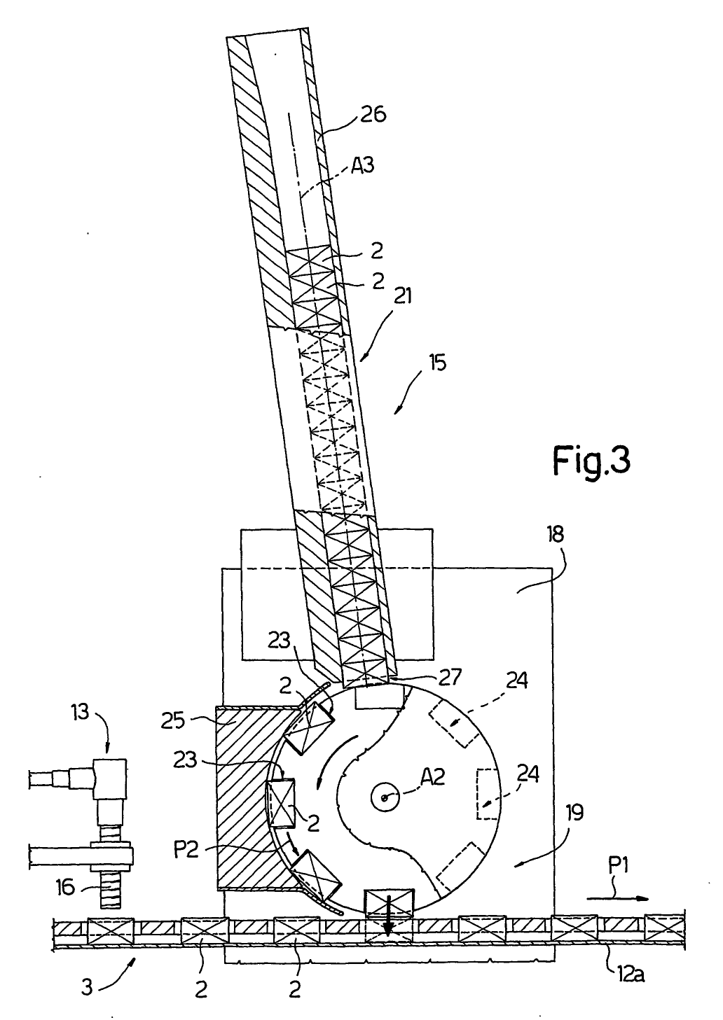

Number 1 in FIG. 1 indicates as a whole a unit for reordering sweets 2, which are fed to unit 1 in bulk, and are arranged by unit 1 into a given succession enabling wrapping of sweets 2.

Sweets 2 are square parallelepiped-shaped, and are fed in bulk to unit 1 in known manner not shown in the accompanying drawings. Unit 1 comprises a supporting frame F; a disk 3 supported on a shaft 4 and rotating about a vertical axis A1; a fixed ring 5; and a makeup device 6 for making up sweets 2. An extraction station 7 for extracting sweets 2 from disk 3 is located alongside the periphery of disk 3 to extract sweets 2 from unit 1 and feed sweets 2 to a known wrapping machine not shown.

Disk 3 comprises a hub 8; an annular plate 9 fitted to hub 8 and having, about its outer edge, a number of openings defining seats 10 equally spaced about axis A1; and a truncated-cone-shaped plate 11 fitted to hub 8, and located over plate 9, with its convexity facing upwards and sloping down to seats 10. Seats 10 are arranged along a circular first path P1 extending about axis A1, and along which are located makeup device 6 and extraction station 7. Ring 5 extends about axis A1, has a U-shaped section, and comprises a horizontal portion 12a located underneath plate 9 at seats 10; a vertical portion 12b at the outer edge of plate 9; and a portion 12c extending over plate 9, close to seats 10.

Makeup device 6 comprises a detector 13; a control unit 14; and a feed device 15 for supplying sweets 2.

Detector 13, feed device 15, and extraction station 7 are located in succession along path P1 in the traveling direction of seats 10. Detector 13 comprises an optical sensor 16 located over disk 3 along path P1, and which, in use, emits a signal S. Control unit 14 is connected to sensor 16, and, on the basis of discriminating values, processes signal S, and emits an error signal E in the event of given conditions, as described later on. Unit 14 is also connected to feed device 15 to command supply of sweets 2 by device 15; and to a position sensor 17 about shaft 4.

Device 15 comprises a vertical supporting plate 18 fixed to frame F; a conveyor 19; a step motor 20 for driving conveyor 19; and a store 21 over conveyor 19.

Conveyor 19 comprises a cylindrical wheel 22 rotating about a horizontal axis A2; and a succession of pockets 23 formed in the periphery of wheel 22 and defining respective seats 24 for sweets 2. Conveyor 19 also comprises a guide 25 fixed to plate 18 and facing the periphery of wheel 22 to retain sweets 2 inside pockets 23. Pockets 23, in fact, travel along a circular path P2 of sweets 2, which extends in a plane perpendicular to plate 9, i.e. to the plane of path P1, and is substantially tangent to path P1. Guide 25 extends along path P2, between store 21 and plate 9; and store 21 comprises a conduit 26 extending along an axis A3, which intersects axis A2 and slopes slightly with respect to vertical axis A1.

Conduit 26 has an outlet 27, which is tangent to the periphery of wheel 22 to feed sweets 2 into seats 24 on wheel 22.

In actual use, sweets 2 are fed in bulk onto the center of truncated-cone-shaped plate 11, which rotates together with disk 3 about axis A1. The centrifugal force produced by rotation of disk 3, on the one hand, and the shape of plate 11 sloping down to seats 10, on the other, push sweets 2 towards the periphery of disk 3, towards seats 10, and onto portion 12c of fixed ring 5. Sweets 2, which are randomly arranged and oriented, are brought into contact with portion 12b, which brakes and changes the orientation of sweets 2 carried on disk 3. When the orientation and position of a sweet 2 coincide with the position of a seat 10, sweet 2 drops through seat 10 onto portion 12a of plate 5, and is fed in this position by disk 3 to extraction station 7.

Detector 13 constantly monitors the fill status of each seat 10 at a given point along path P1, and emits a signal S, which varies depending on the distance between optical sensor 16 and the surface facing sensor 16, and which assumes a first value when sensor 16 faces plate 9, a second value, greater than the first, when sensor 16 faces a sweet 2, and a third value, smaller than the first, when there is no sweet 2, i.e. seat 10 is empty, so that sensor 16 faces portion 12a of plate 5.

When the value of signal S is below the threshold value determined experimentally, control unit 14 emits an error signal E indicating an empty seat 10, and which activates motor 20 of feed device 15. Emission of error signal E is subordinate to an angle signal emitted by sensor 17. In other words, motor 20 moves wheel 22 one step as seat 10 passes beneath wheel 22, so that a pocket 23 is positioned directly beneath wheel 22, and a sweet 2 is transferred by force of gravity from pocket 23 to seat 10 underneath.

As it rotates about axis A2, wheel 22 positions an empty pocket 23 at outlet 27 of conduit 26, from which the whole succession of sweets 2 drops down by force of gravity, and the first sweet 2 in the succession engages the pocket 23 at outlet 27.

Obviously, store 21 must be fed with an orderly succession of sweets 2 to fill any seats 10 not engaged by respective sweets 2.

Though the above description refers to square parallelepiped-shaped sweets 2, the present invention applies to sweets of any shape. That is, plate 9, wheel 22 and conduit 26 of the unit described need simply be replaced with a plate, wheel and conduit with seats and sections of the same shape as the sweets involved.

1. A unit for reordering confectionery products, such as sweets and similar; the unit (1) comprising a spacing disk (3), which receives sweets (2) in bulk, comprises a number of peripheral first seats (10), each for receiving a respective sweet (2), and rotates about a substantially vertical first axis (A1) to feed said first seats (10) along a first path (P1) through an extraction station (7) for extracting the sweets (2); the unit (1) being characterized by comprising a makeup device (6) for making up the sweets (2) inside any vacant first seats (10); the makeup device (6) comprising a detector (13) located along said first path (P1) to detect any vacant first seats (10), and a sweet feed device (2) located along said first path (P1), between said detector (13) and said extraction station (7), to feed sweets (2) selectively into the vacant said first seats (10).

2. A unit as claimed in claim 1, characterized in that said feed device (15) comprises an orderly succession of second seats (24) movable along a second path (P2) substantially tangent to the first path (P1) and over the first path (P1).

3. A unit as claimed in claim 2, characterized in that said feed device (15) comprises a wheel (22) rotating about a substantially horizontal second axis (A2).

4. A unit as claimed in claim 3, characterized in that said second seats (24) are defined by respective pockets (23) extending radially towards said second axis (A2), so that a sweet (2) is expelled by force of gravity from the respective second seat (24).

5. A unit as claimed in claim 4, characterized in that said feed device (15) comprises a guide (25) parallel to a portion of said second path (P2) to retain the sweets (2) inside said second seats (24).

6. A unit as claimed in claim 3, characterized in that said feed device (15) comprises an actuator (20) for operating said wheel (22) as a function of a signal (S) emitted by said detector (13).

7. A unit as claimed in claim 6, characterized in that said makeup device (6) comprises a control unit (14) for processing the emitted said signal (S) and supplying an error signal (E) related to the status of a vacant first seat (10) to activate said actuator (20).

8. A unit as claimed in claim 7, characterized in that said control unit (14) comprises a position sensor (17) for determining the angular position of said spacing disk (3) and activating said actuator (20) as a function of the position of the spacing disk (3).

9. A unit as claimed in claim 3, characterized in that said feed device (15) comprises a store (21) located at said wheel (22) and for feeding said wheel (22).

10. A unit as claimed in claim 9, characterized in that said store (21) comprises a conduit (26) containing a succession of stacked, equally oriented sweets (2); said conduit (26) having an outlet (27) facing and substantially tangent to said second path (P2) to feed sweets (2) into said second seats (24).

11. A method of reordering confectionery products, such as sweets and similar; the method comprising feeding sweets (2) in bulk onto a spacing disk (3) comprising a number of peripheral first seats (10), each for receiving a respective sweet (2); and rotating the spacing disk (3) about a substantially vertical first axis (A1) to feed said first seats (10) along a first path (P1) through an extraction station (7) for extracting the sweets (2); the method being characterized by detecting any vacant first seats (10) by means of a detector (13) located upstream from the extraction station (7); and making up the sweets (2) inside the vacant first seats (10), between said detector (13) and the extraction station (7), by means of a sweet feed device (15).

12. A method as claimed in claim 11, characterized by feeding sweets (2) along a second path (P2) by means of a feed device (15); the second path (P2) being substantially tangent to the first path (P1) and over the first path (P1).

13. A method as claimed in claim 12, characterized by transferring sweets (2) from said feed device (15) to the empty said first seats (10).

14. A method as claimed in claim 13, characterized in that said feed device (15) comprises an actuator (20) for activating transfer of said sweets (2); said actuator (20) being activated as a function of a signal (S) emitted by said detector (13).

15. A method as claimed in claim 14, characterized by supplying an error signal (E), which is a function of the emitted signal (S), and is related to the status of a vacant first seat (10) to activate said actuator (20).

16. A method as claimed in claim 15, characterized by detecting the angular position of said spacing disk (3), and activating said actuator (20) as a function of the position of the spacing disk (3).

17. A method as claimed in claim 13, characterized in that said feed device (15) comprises a wheel (22) rotating about a second axis (A2) and having a number of second seats (24) equally spaced about said second axis (A2); and a store (21) located at said wheel (22) and for feeding said wheel (22).

18. A method as claimed in claim 17, characterized in that said sweets (2) are stacked in said store (21) and fed by force of gravity to said wheel (22).
